(19) United States
(12) Patent Application Publication
(10) Pub. No.: US 2017/0154716 A1
(43) Pub. Date: Jun. 1, 2017

(54) MULTI-PIECE ARMATURE AND SOLENOID WITH AMPLIFIED STROKE

(71) Applicant: Eaton Corporation, Cleveland, OH (US)

(72) Inventor: RAYMOND BRUCE MCLAUCHLAN, MACOMB TOWNSHIP, MI (US)

(73) Assignee: Eaton Corporation, Cleveland, OH (US)

(21) Appl. No.: 15/430,458

(22) Filed: Feb. 11, 2017

Related U.S. Application Data
(63) Continuation-in-part of application No. PCT/US2016/017648, filed on Feb. 12, 2016.
(60) Provisional application No. 62/249,237, filed on Oct. 31, 2015.
(60) Provisional application No. 62/115,620, filed on Feb. 12, 2015.
(60) Provisional application No. 62/141,718, filed on Apr. 1, 2015.

(51) Int. Cl. H01F 7/16; F16K 31/06

(52) U.S. Cl. CPC H01F 7/1607; F16K 31/0658

(57) ABSTRACT

A solenoid assembly, comprises a pole piece comprising an inner chamber. An electromagnetic signal source surrounds the pole piece. An armature is configured to move within the inner chamber when an electromagnetic signal is transmitted by the electromagnetic signal source, the armature comprising a rotating member installed within the armature, and the rotating member is configured to rotate within the armature and against the inner chamber.

### FIELD

This application relates to multi-piece armatures and methods of assembling multi-piece armatures.

### BACKGROUND

Solenoid assemblies apply an electromagnetic signal to an armature to move the armature up or down. The distance that the armature travels is the stroke. To get a large distance stroke, it is necessary to use a longer solenoid assembly and to give up some of the force of the armature's motion, or it is necessary to use a larger supply of electromagnetic force. This increases the cost and size of the solenoid assembly.

Manufacturing a solenoid armature can be expensive and time consuming when the armature includes recesses, cavities, or hollow portions in the walls of the armature.

### SUMMARY

The devices disclosed herein overcome the above disadvantages and improves the art by way of a solenoid assembly comprising a sliding arm with a stroke longer than the stroke of the armature.

A solenoid assembly, comprises a pole piece comprising an inner chamber. An electromagnetic signal source surrounds the pole piece. An armature is configured to move in the inner chamber when an electromagnetic signal is transmitted by the electromagnetic signal source, the armature comprising a rotating member installed within the armature, and the rotating member is configured to rotate within the armature and against the inner chamber.

A solenoid assembly comprises a pole piece. The pole piece comprises an inner chamber and inner grooves in the inner chamber, wherein the inner grooves are spaced to interface with a gear. The solenoid assembly comprises an electromagnetic signal source surrounding the pole piece an armature configured to move in the inner chamber when an electromagnetic signal is transmitted by the electromagnetic signal source.

A valve assembly comprises a flow path through a housing, at least one valve configured to selectively open and close the flow path, and a solenoid assembly. The solenoid assembly comprises a pole piece. The pole piece comprises an inner chamber and inner grooves in the inner chamber. The inner grooves are spaced to interface with a gear. The solenoid assembly further comprises an electromagnetic signal source surrounding the pole piece and an armature configured to move in the inner chamber when an electromagnetic signal is transmitted by the electromagnetic signal source.

A solenoid assembly comprises a pole piece. The pole piece comprises an inner chamber and an inner surface on the inner chamber. The inner surface contacts a rotating member. The solenoid assembly further comprises an electromagnetic signal source surrounding the pole piece and an armature configured to move in the inner chamber when an electromagnetic signal is transmitted by the electromagnetic signal source.

A valve assembly comprises a flow path through a housing, at least one valve configured to selectively open and close the flow path, and a solenoid assembly. The solenoid assembly comprises a pole piece. The pole piece comprises an inner chamber and an inner surface on the inner chamber. The inner surface contacts a rotating member. The solenoid assembly further comprises an electromagnetic signal source surrounding the pole piece and an armature configured to move in the inner chamber when an electromagnetic signal is transmitted by the electromagnetic signal source.

A solenoid assembly can comprise an armature assembled by a plurality of portions. An armature assembly comprises a first portion comprising a recess. The armature assembly comprises a second portion comprising a hole, a pin in the recess, and a rotating member surrounding the pin. The pin is press-fit into the hole.

An armature assembly comprises a first portion comprising a first recess, the first recess comprising a first sidewall. The armature assembly comprises a second portion comprising a second recess, the second recess comprising a second sidewall. The armature assembly comprises a first rotating member. The first portion is fixed to the second portion. The first sidewall and the second sidewall form a cavity. The cavity surrounds the rotating member.

A method of assembling an armature comprising the steps of placing a rotating member on a dowel, wherein the dowel is fixed to a first portion of an armature, and press-fitting the dowel into a hole on a second portion of the armature.

A method of assembling an armature comprising the steps of placing a rotating member in a first recess in a first portion of an armature and fixing the first portion of an armature to a second portion of the armature such that the rotating member is partially surrounded by a second recess in the second portion of an armature.

A ferromagnetic armature for a solenoid assembly comprises a first portion and a second portion. The first portion comprises a recess or a pocket, an inner side, an outer side and a thickness between the inner side and the outer side. A first pin and a second pin span between the first portion and the second portion to couple the first portion to the second portion. A rotating member is installed in the recess or in the pocket of the first portion. The rotating member is configured to rotate within the first portion. The rotating member comprises a diameter greater than the thickness of the first portion, such that the rotating member extends beyond the inner side and beyond the outer side.

Additional objects and advantages will be set forth in part in the description which follows, and in part will be obvious from the description, or may be learned by practice of the disclosure. The objects and advantages will also be realized and attained by means of the elements and combinations particularly pointed out in the appended claims.

It is to be understood that both the foregoing general description and the following detailed description are exemplary and explanatory only and are not restrictive of the claimed invention.

### BRIEF DESCRIPTION OF THE DRAWINGS

FIG. 1 is cross-sectional of a pole piece assembly with an armature and a sliding arm.

FIG. 2A is a view of a solenoid assembly in a casing.

FIG. 2B is an exploded view of a solenoid assembly.

FIG. 3 is a cross-sectional view of an electromagnetic signal source around a pole piece, the pole piece having an inner chamber for movement of an armature therein.

FIG. 4 is a cross-sectional view of a fuel valve assembly comprising a solenoid assembly.

FIG. 5 is a cross-sectional view of a pole piece assembly with balls instead of gears.

FIG. 6A is a cross-sectional view of a rotating member arrangement.

FIGS. 6B-6C are cross-sectional views of rotating members.

FIG. 7A is a view of a first portion of an armature with a pin in a recess.

FIG. 7B is a view an armature with a first portion fixed to a second portion.

### DETAILED DESCRIPTION

Reference will now be made in detail to the examples, which are illustrated in the accompanying drawings. Wherever possible, the same reference numbers will be used throughout the drawings to refer to the same or like parts. Directional references such as “left” and “right” are for ease of reference to the figures.

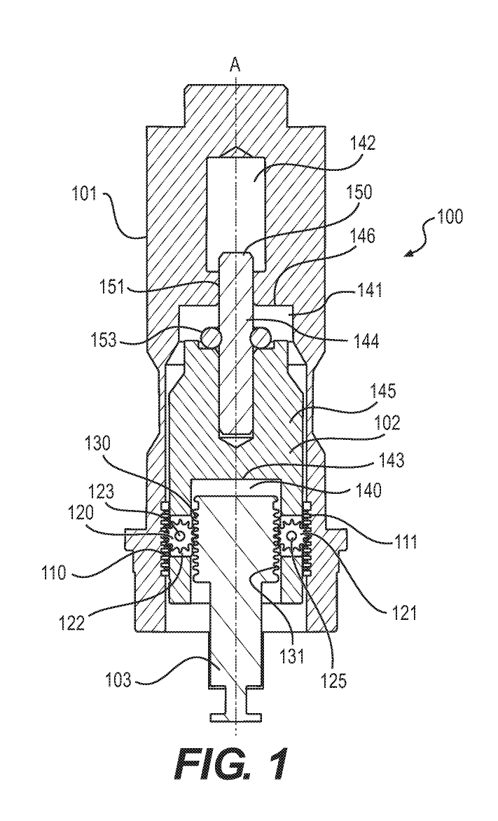

FIG. 1 shows a cross-sectional view of a pole piece assembly 100 with an armature 102 and a sliding arm 103. The armature 102 is located in an inner chamber 141 of the pole piece 101. The armature 102 can move along axis A toward and away from the back wall 146 of the inner chamber 141.

At least one gear 120 can be seated on the armature 102. The gear 120 has teeth 122 that interface with inner grooves 110 in the inner chamber 141. A second gear 121 can also be seated on the armature 102. The second gear 121 can also have teeth 122 that interface with a second set of inner groves 111 in the inner chamber 141. The gears 120, 121 in this example are spur gears, though other types of gears or even wheels can be used instead.

The gears 120, 121 are seated on the armature 102 in such a way that they do not move along axis A on the armature 102. The gears 120, 121, however, can rotate, thereby allowing armature 102 to move toward and away from back wall 146. The gears 120, 121 can include a bearing or wheel that rotates around a shaft or dowel.

The armature 102 can be a single unit or it can include a first piece 144 connected to a second piece 145. The first piece 144 can be a dowel, pin, or shaft press-fit or snap fit into the second piece 145. An end 150 of the first piece 144 can extend into a hollow portion 142 of the pole piece 101. The first piece 144 can be slip-fit into a passageway 151 connecting the hollow portion 142 to the inner chamber 141. This arrangement allows the armature 102 to move axially within the pole piece 101 while reducing movement or vibrations in directions away from axis A. This arrangement helps to keep the pole piece 101 aligned along axis A with the armature 102 and the sliding arm 103.

The sliding arm 103 is located in a hollow portion 140 in the armature 102. The sliding arm 103 can move along axis A towards and away from the back wall 143 of the hollow portion 140. The sliding arm 103 has grooves 130 spaced apart to interface with the teeth 122 of the gear 120 seated on the armature 102. The sliding arm can have multiple sets of grooves 130, 131 configured to interface with both gears 120, 121.

When the sliding arm 103 moves, the gears 120, 121 rotate. Likewise, when the armature 102 moves, the gears 120, 121 rotate. For example, when the armature 102 moves away from back wall 146, gear teeth 122 rotates in a clockwise direction and gear 121 rotates in a counterclockwise direction. This rotation pushes the sliding arm away from back wall 143 of the armature 102. Thus, the sliding arm moves along axis A at a faster rate than the armature 102. For example, if sliding arm is moving along axis A at a rate Rₛ relative to the armature 102 while the armature 102 is also moving along axis A at a rate Rₐ relative to the pole piece 101, which is not moving along axis A, then the sliding arm 103 is moving at a rate of Rₛ+Rₐ along axis A relative to the stationary pole piece 101.

The spacing of gear teeth 122, the spacing of inner groves 110, 111, and the spacing of grooves 130, 131 can be set to determine the axial movement, or stroke, of the armature 102 and sliding arm 103.

The depth of the hollow portion 142 and the inner chamber 141 can be selected to meet the needs of the solenoid assembly 200, 300 and when affiliated, valve assembly, such as valve assembly 400. For example, these areas can be made deeper to allow the armature 102 more room to move a greater distance along axis A. Likewise, hollow portion 140 can be made deeper to allow the sliding arm 103 to move a greater distance along axis A. This axial movement can be called a stroke. Thus, length of the stroke of the sliding arm 103 is longer than the stroke of the armature 102. Also, less magnetic force needs to be applied to move the sliding arm 103 and armature 102.

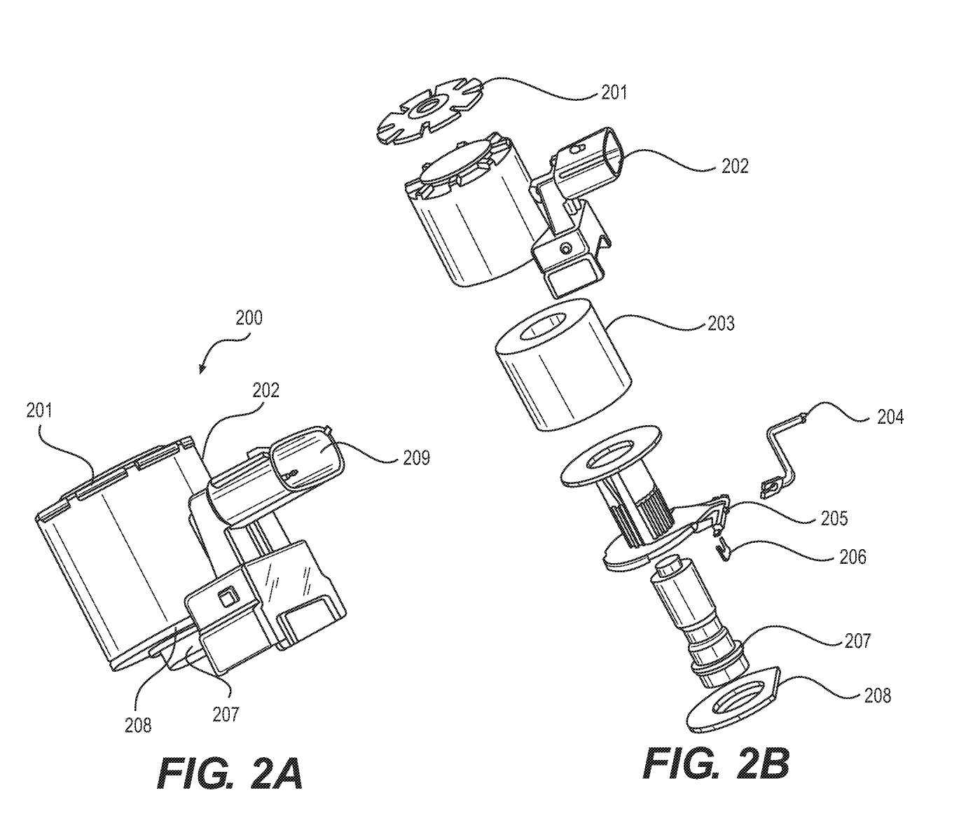

FIG. 2A is a view of an assembled solenoid assembly 200. FIG. 2A includes an upper flux collector 201, a casing 202, an electrical input port 209, a lower flux collector 208, and a pole piece 207. An exploded view of the solenoid assembly 200 is shown in FIG. 2B. The solenoid assembly includes an upper flux collector 201, casing 202, magnet wire 203, terminal 204, bobbin 205, diode 206, pole piece 207, and lower flux collector 208.

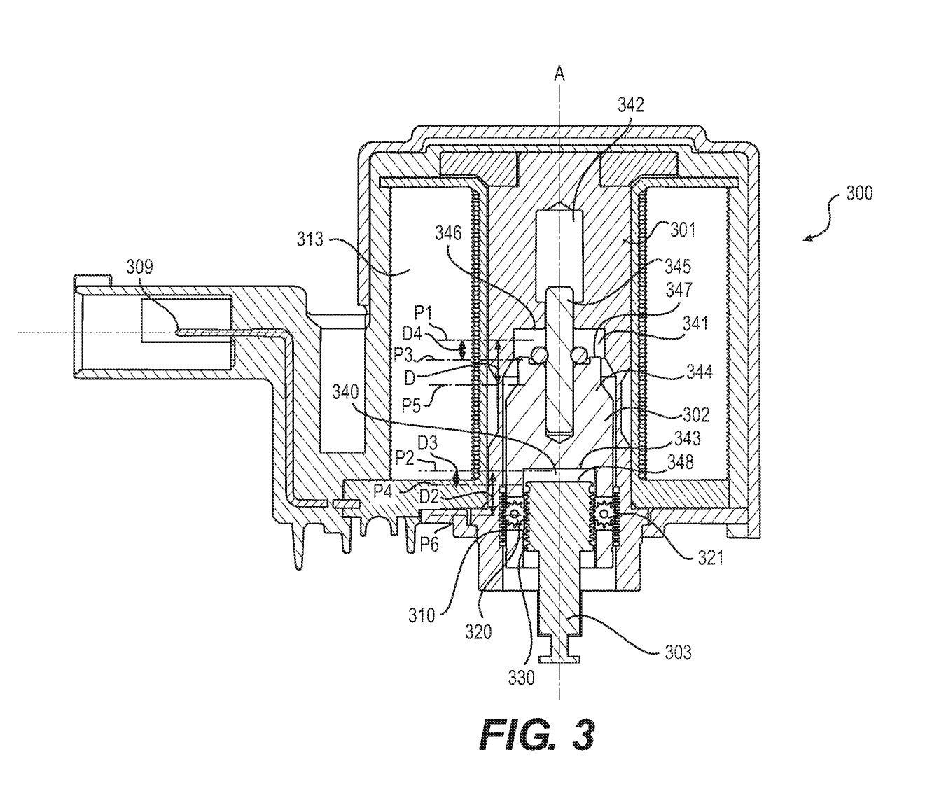

FIG. 3 is a cross-sectional view of a solenoid assembly 300. Solenoid assembly 300 includes a pole piece 301 surrounded by magnetic wire 313. An armature 302 is located in the pole piece 301 and a sliding arm 303 is located in the armature 302. The pole piece 301, armature 302, and sliding arm 303 are aligned along axis A.

FIG. 3 shows a solenoid assembly 300 with the sliding arm 303 in a lifted position. The original position of the top 348 of the sliding arm is marked as P2. This is the position where the sliding arm 303 is completely lifted, marking its upper boundary along axis A. Position P6 marks the position of the top 348 of the sliding arm 303 in an extended position. The sliding arm 303 reaches the extended position after the sliding arm 303 moves away from back wall 342 of the armature 302. D2 is the distance between P2 and P6, or in other words, D2 is equal to the distance that the sliding arm 303 traveled from its original position P2 to an extended position P6. D2 can be called the distance of the stroke of the sliding arm 303 in the extended position.

D2 is greater than D. D is the distance that the armature 302 traveled from the original position P1 of the top 347 of the armature 302 to an extended position P5 of the top 347 of the armature 302. Thus, the stroke of the sliding arm 303 is longer than the stroke of the armature 302 at the extended position.

The relationship between the stroke distance of the sliding arm 303 to the stroke distance of the armature 302 at the extended position can be calculated using equation (1), where

D2=D*N eq. (1)

D2=distance of the stroke of the sliding arm at the extended position
D=distance of the stroke of the armature at the extended position
N=a factor which equals a number greater than 1

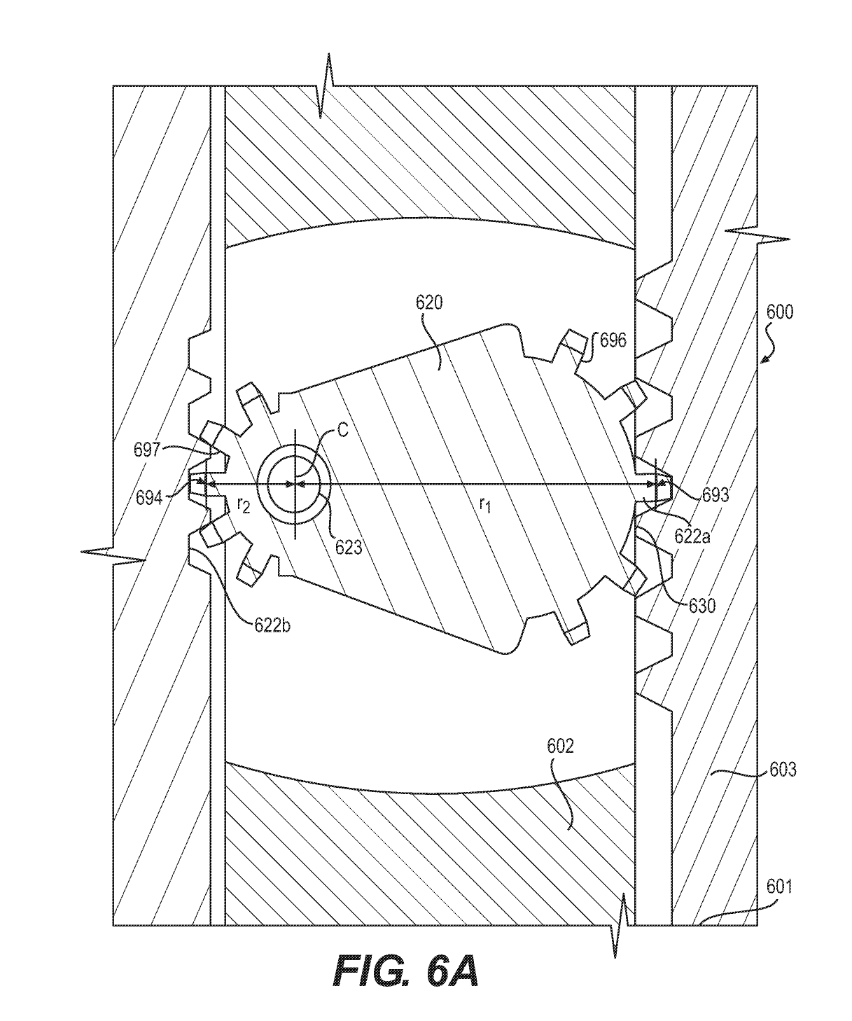

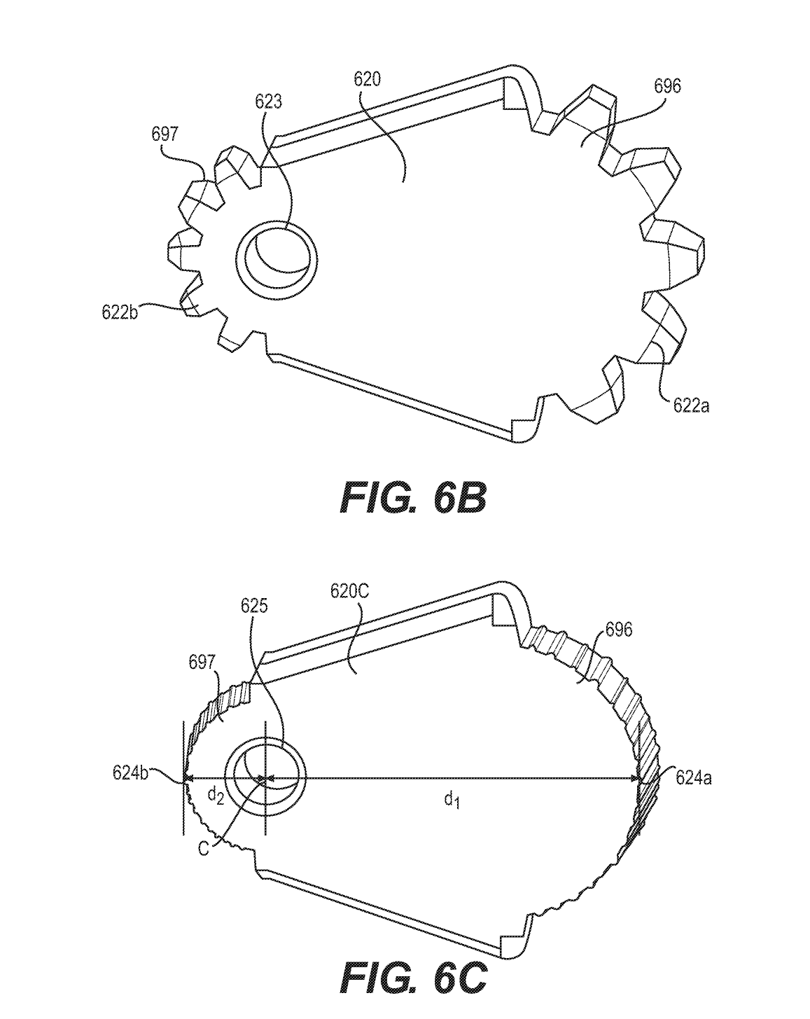

The magnitude of N can depend on many factors, including the shape and size of the rotating members, such as balls, rollers and gears, attached to the armature. FIG. 6A shows a fan gear 620 having a first side 696 with a distance of r₁ from the center C of the gear 620 to the first pitch surface 693 and a second side 697 with a distance of r₂ from the center C of the gear 620 to the second pitch surface 694. Because r₁ is greater than r₂, the rotational speed of gear 620 at the first pitch surface 693 is greater than the rotational speed at the second pitch surface 694. When teeth 622a mesh with grooves 630 on sliding arm 603 and teeth 622b mesh with grooves 610 on pole piece 601 as shown in FIG. 6A, the sliding arm 603 moves faster than the armature 602. This means the sliding arm 603 also has a longer stroke than the armature 602. One can increase or decrease both the speed and stroke of the sliding arm 603 by changing the sizes and shapes of rotating gear 620, pole piece 601, armature 602, and sliding arm 603.

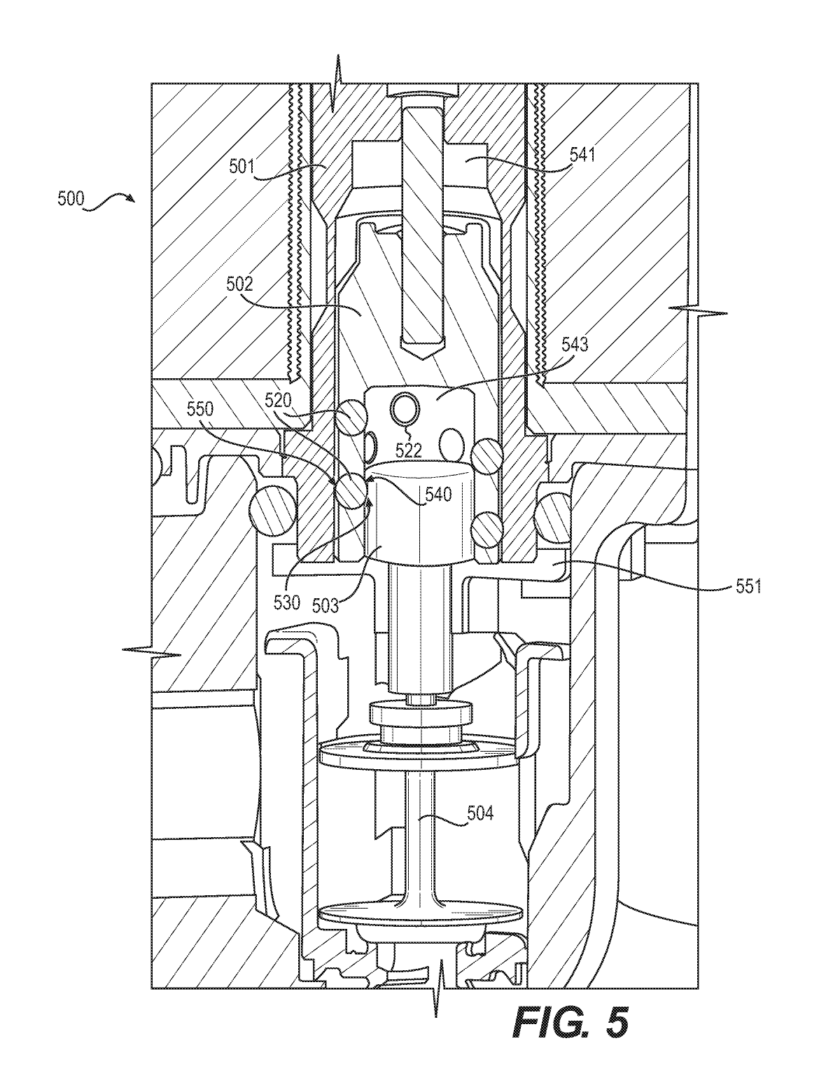

When the rotating members, such as rollers or gears, are uniform in size and shape, N equals 2. FIG. 5 shows such an arrangement. Thus, the sliding arm 503 moves twice as fast as the armature 502. And the sliding arm 503 can have a stroke twice as long as the stroke of armature 502.

Both rollers and gears are rotating members that can be used to amplify the stroke of a sliding arm. FIG. 6B shows an example of a toothed gear 620 with first teeth 622a on first side 696 and second teeth 622b on second side 697. The rotating member need not be a roller or toothed gear. For example, as shown in FIG. 6C, rotating member 620C can amplify the stroke of a sliding arm. Instead of having teeth, rotating member 620C has a textured surface, for example, with bumps 624a and bumps 624b. Rotating member 620C need not have a textured surface. Frictional forces can be sufficient when sides 696, 697 are smooth or when the sides 696, 697 are appropriately coated. Such techniques can be applied above to replace spur gears 120, 121 with a textured, smooth, or coated wheel or bearing.

Rotating member 620C can contact the outer surface of a sliding arm in a similar way as rotating gear 620 contacts the sliding arm 603 in FIG. 6A except that rotating member 620C does not have teeth that engage with grooves in the sliding arm. Rotating member 620C can also contact the outer surface of a pole piece like the rotating gear 620 of FIG. 6A contacts pole piece 601 except that rotating member 620C does not have teeth that engage with grooves in the pole piece.

Rotating member 620C has a first side 696 with a distance d₁ away from the center C of rotating member 620C and a second side 697 with a distance of d₂away from the center C of rotating member 620C. Because d₁ is greater than d₂, rotating member 620C amplifies the stroke of a sliding arm. One can adjust d₁ and d₂ to achieve the desired amplification.

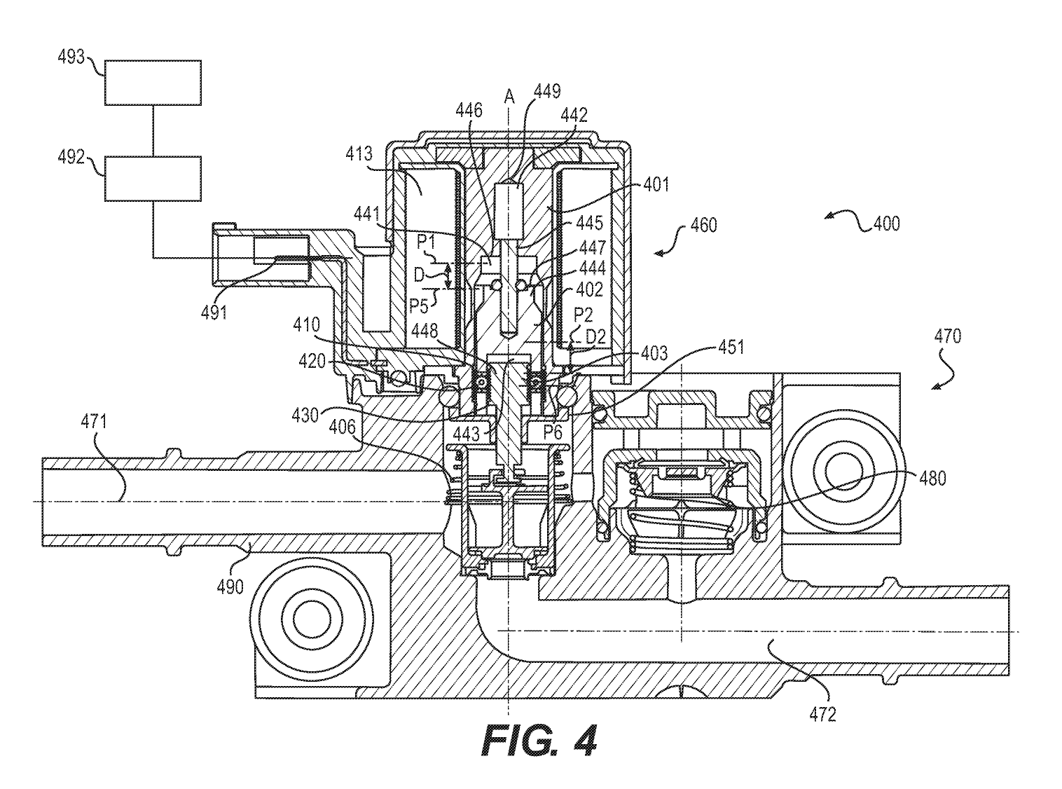

The amplified stroke is advantageous in many applications. One example application is fuel valve actuation, where a solenoid assists with fluid pressure control. FIG. 4 shows a valve assembly 400 with a solenoid assembly 460 in the extended position, where the armature 302 has moved a distance of D from its original position P1 and the sliding arm 403 has traveled a distance of D2 from its original position P2. FIG. 3 shows the sliding arm 303 and the armature 302 in a lifted position, where both the sliding arm 303 and the armature 302 have moved away from the extended position towards back wall 346 of the inner chamber 341.

The distance between the original position P1 of the armature 302 and the lifted position P3 of the armature 302 is D4. The distance between the original position P2 of the sliding arm 303 and the lifted position P4 of the sliding arm 303 is D3. In FIG. 3, D3 is less than D4. This means that the distance between the top 348 of the sliding arm 303 and its original position P2 is less than the distance between the top 347 of the armature 302 and its original position P1. Even though the sliding arm 303, when in the extended position, has a longer stroke than the armature 302, the sliding arm 303 can move closer to its original position P2 than the armature 302 can move to its original position P1 when in the lifted position. This is possible because the sliding arm 303 moves at a faster rate than does the armature 302. Gears 120, 121 allow the sliding arm 303 to move at a faster rate. When the sliding arm 303 is moving downward to the extended position, gears 120, 121 push the sliding arm 303 downward away from the armature 302, thereby causing the sliding arm 303 to move downward faster than the armature 302. When the sliding arm 303 is moving upward to the lifted position, gears 120, 121 pull the sliding arm 303 upward toward the armature 302, thereby causing the sliding arm 303 to move upward faster than the armature 302.

FIG. 4 shows a cross-sectional of a valve assembly 400 with a solenoid assembly 460. The valve assembly 400 has a first flow path 471 in the housing 490 of the valve assembly 400 that can be connected to second flow path 472. Together, first flow path 471 and second flow path 472 can be a single flow path when connected. Fluid can flow from first flow path 471 to second flow path 472 or from second flow path 472 to first flow path 471. A check valve 480 or other valve can be connected to either first flow path 471 or second flow path 472. Check valve 480, as shown in FIG. 4, can serve to regulate fluid pressure, for example, opening when the pressure in flow path 471 reaches a certain threshold, thereby allowing fluid to flow from first flow path 471 to second flow path 472.

Valve 404 can allow or prevent a fluid from flowing between first flow path 471 and second flow path 472. Valve 404 can be a poppet valve surrounded by an outer valve 405. When in the lifted position, valve 404 allows fluid to flow either from flow path 471 to flow path 472 or from flow path 472 to flow path 417. The flow can occur even when outer valve 405 is closed when valve 404 is in the lifted position. FIG. 4 shows an arrangement where both valve 404 and outer valve 405 are closed. Pressure in second flow path 472 can build to a point where it raises outer valve 405, allowing fluid to flow from second flow path 472 to first flow path 471. To raise outer valve 405, the pressure in flow path 472 must overcome the force exerted by spring 406, which biases outer valve 405 toward the closed position.

The sliding arm 403 can be linked to valve 404. Thus, valve 404 moves along axis A as the sliding arm 403 moves along axis A. When the sliding arm 403 is in the extended position, valve 404 is closed, as show in FIG. 4. When the sliding arm is in the lifted position, valve 404 is open, thereby allowing fluid to flow from first flow path 471 to second flow path 472.

Valve 404 is lifted when an electric signal or current runs through the magnetic wire 413. The magnetic wire 413 is an electromagnetic signal source. An electricity source, for example, an alternator, battery, generator, or other electric current source 493 can provide the electrical current. The current can be controlled by a control system 492, for example, a computer or microcomputer. When electric current flows through the magnetic wire 413, the magnetic wire 413 transmits an electromagnetic signal and a magnetic field is created. This creates a magnetic force, which can attract metallic or other ferromagnetic materials.

The armature 402 can comprise metallic or ferromagnetic materials. For example, first portion 445 can be made of metal. The electromagnetic signal created by current passing through the magnetic wire attracts the first portion 445 of the armature 402. The magnetic force of the electromagnetic signal can pull first portion 445 upward toward back wall 449 of the hollow portion 442 of the pole piece 401. The magnetic force can also push first portion 445 downward away from back wall 449, for example, when first portion 445 is made of a permanent magnet. When the first portion 445 or any portion of the armature 402 is made of metallic or ferromagnetic material, the sliding arm can be made of a nonmetallic or nonferromagnetic material. Thus, sliding arm 403 need not be affected by the magnetic force. The sliding arm 403 and the second portion 444 of the armature can be made of a plastic or other lightweight moldable material.

The amount of magnetic force depends on the amount of current flowing through the magnetic wire 413. The magnetic force also depends on the number of coils of wire. The force can enter the solenoid assembly 460 through terminal 491. Terminal 491 can be connected to an electric current source 493 and a control system 492, for example, a microcomputer or other control system 492. The control system 492 can be programmed to send a selected amount of electrical current at a selected time, thereby controlling when valve 404 is opened or closed.

A spring can bias valve 404 to remain in the closed position until valve 404 is lifted by the solenoid assembly. Gravity and fluid pressure can also bias valve 404 to remain in the closed position. The magnetic force, therefore, must be large enough to overcome the force exerted by any biasing force.

FIG. 5 shows a cross-sectional of a pole piece assembly 500 comprising bearing balls for the rollers 520 in pockets 522. The pole piece assembly 500 of FIG. 5 can amplify the stroke of sliding arm 503. Like the gears 120, 121 of FIG. 1, rollers 520 can rotate thereby pushing sliding arm 503 downward when armature 502 moves downward. And rollers 520 can rotate pushing sliding arm 503 upward when armature 502 moves upward. The outer surface 540 of rollers 520 engages the outer surface 530 of sliding arm 503. The engagement is maintained by frictional forces, thereby preventing rollers 520 and sliding arm 503 from slipping relative to each other. The outer surface 540 of rollers 520 engages the surface 550 of inner chamber 541.

Rollers 520, sliding arm 503, and pole piece 501 can be made of an anti-slip material to increase the friction forces where rollers 520 contact sliding arm 503 and where rollers 520 contact the inner chamber 541 of pole piece 501. Rollers 520, sliding arm 503, and pole piece 501 can also be coated with an anti-slip material to increase the friction forces. Rollers 520 can be balls, cylinders, or other shapes. Rotating members, for example, the rotating member shown in FIG. 6C, can be made of anti-slip material or coated with anti-slip material. Texture, for example bumps, knurls, or ridges, can be added to the surfaces of the rollers, gears, other rotating members, sliding arm, and pole piece to increase the frictional forces, thereby preventing slip. These parts can comprise the same anti-slip material or comprise different anti-slip materials.

Using rotating members that rotate, or move around an axis or center, such as bearing balls, fan-shaped gears, or other rollers, in an armature of a solenoid valve can amplify the stroke of the sliding arm and decrease the size and weight of the solenoid valve. Using a symmetrical, circular gear amplifies the stroke and speed by a factor of 2. Using a fan-shaped gear can amplify the stroke by factors of 3, 4, and larger. This can reduce the overall size of the solenoid valve. Also, less magnetic force is required to move the sliding arm, thus the solenoid size and weight is further reduced as less magnetic winding is required.

Manufacturing a solenoid armature can be expensive and time consuming when the armature includes recesses, cavities, or hollow portions in the walls of the armature. It is even more difficult to manufacture an armature that includes rotating parts, for example, rotating gears or rollers.

The armature 102, 302, 402, 502 can be formed similarly to armature 701 to include two portions that snap together. The two portions can each have a substantially flat face, such as face 766, that snap together. The faces can include recesses 785, 784 that surround a gear or other rotating member such as a ball or wheel. The recesses can include pin, such as a dowel pin, that holds the rotating member. The pin can also fit into holes on opposing faces, thereby holding the two portions of the armature together. Or, a plurality of pockets 522 can be formed in the two portions to receive balls. A snap-fit or press fit can be used to secure the opposing faces together. This arrangement allows one to manufacture the two portions of the armature 701, then place a gear or balls in the armature, and then assemble the armature in the pole piece. The two portions can be fixed together using a variety of methods, including welding, using a series of pins that snap-fit into opposing holes, and other methods of bonding.

A ferromagnetic armature for reciprocating in a solenoid assembly can comprise a first portion 702 and a second portion 703. First portion comprises a recess 784, 785 or a pocket 522, a back wall 743, an inner side surrounding a hollow portion 740, an outer side and a thickness between the inner side and the outer side. The outer side can comprise a cylindrical first body area 748 and an optional flat portion 762 for sliding within a pole piece. A rotating member, such as a ball, cylinder, gear or wheel can comprise a diameter greater than the thickness of the first portion, such that the rotating member extends beyond the inner side and beyond the outer side.

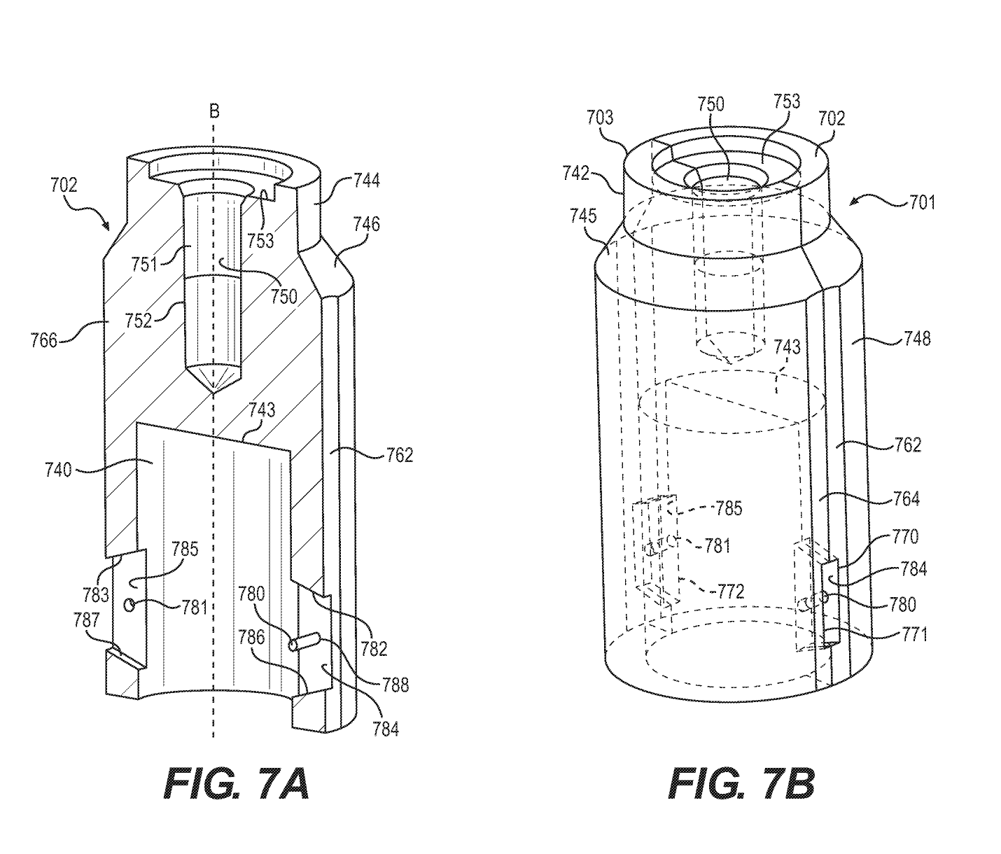

FIG. 7A is cross-sectional view of first portion 702 of an armature 701 with a pin 708 in a hole 788 in a recess 784. First portion 702 is a mirror image about a center longitudinal axis B. When installed in pole piece assembly 100, axis B is coextensive with axis A. Being a mirror image in this instance inures manufacturing benefits by reducing custom stock. First armature portion 702 and second armature portion 703 can be identical.

Pin 780 can be press fit into a corresponding hole on a second portion 703 of the armature 701. The hole on the second portion 703 can be located in a recess like the holes 781, 788 in the first portion. Second portion can be identical to the first portion. This allows second portion 703 be fixed onto first portion 702 by press-fitting dowels, shafts, or pins (for example, dowel 123 or shaft 780) into holes on the second portion.

Or, a second pin can be fitted in hole 781. Then, one of gears 120, 121, 320, 321, 420, 620, 620C can be mounted on respective pins 780 in holes 781, 788 of first portion 702. Then, grooves 130, 131 on sliding arm 103 can be aligned with the respective gears for drop-in assembly of the sliding arm 103. Second portion 703 can be aligned and fitted to first portion 702 to mount gears and sliding arm 103 within armature 701. The gears are omitted in FIGS. 7A & 7B for clarity regarding the first and second portions 702, 703.

The pole piece 101 can similarly be halved for drop-in assembly of the geared armature 701 to have alignment with the inner grooves 110, 111. This permits the manufacturer to set an initial open or close position of the poppet valve 504 or other valve.

Or, a “walk-up” assembly method can be used. When the armature 701 is slid in to the pole piece 101, the gears rotate to catch inner grooves 110, 111. The armature 701 walks up in to the pole piece 101. Sliding arm 103, if not drop-in assembled, can be inserted in to armature 701 to be walked-up the armature as the gears rotate.

Further alternatively, instead of the integrated roller 520 and armature 502 assembly of FIG. 5, the first portion 702 and second portion 703 can comprise pockets 522 to form a cage for rollers 520. The rollers 520 can be mounted in the pockets 522 and second portion 703 can be pressed the first portion 702. As above, the sliding arm 103 can be dropped in to couple the armature to the sliding arm 503, or a walk-up technique can be used.

Several other customizations are available. The hole 125 in gear 121 can be centered for symmetrical rotation of gear 121 on pin 780. The pin 780 can be centered in recess 784 likewise for symmetry. A stop plate 451 can be included to limit travel of the inner sliding arm 103. Stop plate can function as a spring plate, to bias a spring.

However, it is possible to move the holes 781, 788 to move the center point C of the gears with respect to the armatures. This can customize the magnitude of N, as discussed above and impact the length of the stroke of the sliding arm with respect to the armature.

Additionally, walls 782, 783, 786, 787 can be slanted as shown or rounded or take other shapes to accommodate the motion of the gears. The walls can provide a stop for the gear motion, especially gears 620, 620C and like gears. Using one or more of the walls 782, 783, 786, 787 as a gear-stop limits the motion of the inner sliding arm 103. This is advantageous in several respects. First, an affiliated valve, such as poppet 504 is limited in travel. Second, a stop plate, such as stop plate 551, becomes optional because the inner sliding arm 103 and armature are retained within the solenoid assembly 200 by the gear abutment with one or more of walls. This reduces weight and cost.

FIG. 7B is a view an armature 701 with a first portion 702 fixed to a second portion 703. The armature can be substantially cylindrical in shape in first body area 748 and include a flat portion 762, 764 in a second body area. Flat portions 762, 764 can form anti-rotation features to help position armature 701 in a solenoid assembly 200. This can help the armature 701 maintain its position when sliding up and down in a piston like fashion.

Other features can comprise a hole 750 for receiving first piece 144 of armature for alignment and coupling with pole piece 101. Hole 750 can comprise first step 751 and second step 752. Another recess 753 can be included for receiving and orienting a ring 153. An optional cylindrical neck 742 and optional tapered neck 745 can be adjusted in shape and size depending upon the internal shape of the pole piece 101.

When first portion 702 is joined to second portion 703, recess 784 faces a mirror-image recess 771 to form a pocket 770. Likewise, recess 785 faces a mirror-image recess to form a second pocket 772. Any one of gears 120, 121, 320, 321, 420, 620, 620C, roller 520, or their equivalents can be seated in the pockets 770, 772.

First and second portions 702, 703 can be formed of a metal for compatibility with the solenoid, such as iron or a magnetic stainless steel. Pins 780 can be formed of a variety of materials, such as a complementary metal or plastic, wood, composite, etc. Ribs, tapers, crush zones and other customary techniques for mounting a dowel pin can be used. Pins 780 can comprise smooth rotating portions and ribbed or otherwise textured fitting portions, where the gear or wheel rotates on the smooth portion while the fitting portions fit in holes 781, 788.

Other implementations will be apparent to those skilled in the art from consideration of the specification and practice of the examples disclosed herein. It is intended that the specification and examples be considered as exemplary only, with the true scope of the invention being indicated by the following claims.

What is claimed is:

1. A solenoid assembly, comprising:
a pole piece, comprising an inner chamber;
an electromagnetic signal source surrounding the pole piece; and
an armature configured to move within the inner chamber when an electromagnetic signal is transmitted by the electromagnetic signal source, the armature comprising a rotating member installed within the armature, and the rotating member configured to rotate within the armature and against the inner chamber.

2. The solenoid assembly of claim 1, wherein the armature comprises a hollow portion, wherein the solenoid assembly further comprises a sliding arm in the hollow portion, wherein the rotating member is further configured to rotate against the sliding arm, and wherein the sliding arm is configured to move in response to the armature movement when the electromagnetic signal is transmitted.

3. The solenoid assembly of claim 2, wherein the hollow portion comprises a back wall, and wherein the sliding arm is selectively movable towards and way from the back wall.

4. The solenoid assembly of claim 2, wherein the rotating member comprises a toothed gear, and wherein the inner chamber further comprises inner grooves spaced to interface with the gear teeth.

5. The solenoid assembly of claim 3, wherein the sliding arm comprises grooves spaced to interface with the gear teeth.

6. The solenoid assembly of claim 5, wherein:
the inner grooves comprise:
a first set of inner grooves, and
a second set of inner grooves opposite the first set of inner grooves;
the outer grooves comprise:
a first set of outer grooves; and
a second set of outer grooves opposite the first set of outer grooves; and
the armature comprises:
the toothed gear between the first set of inner grooves and the first set of outer grooves; and
a second toothed gear between the second set of inner grooves and the second set of outer grooves.

7. The solenoid assembly of claim 6, wherein when the electromagnetic signal source transmits an electromagnetic signal, the armature moves in the inner chamber, the first toothed gear and the second toothed gear rotate, the armature moves relative to the inner grooves, and the sliding arm moves relative to the armature.

8. The solenoid assembly of claim 7, wherein when the armature moves, the armature moves a distance D within the pole piece and the sliding arm moves at least a distance N*D, where N is factor greater than 1.

9. The solenoid assembly of claim 8, where N is a factor equal to or greater than 2.

10. The solenoid assembly of claim 1, wherein the armature comprises a first piece and a second piece fitted to the first piece, wherein the first piece seats in the pole piece, and wherein the second piece receives the sliding arm.

11. The solenoid assembly of claim 10, wherein the first piece comprises a ferromagnetic material.

12. The solenoid assembly of claim 2, wherein the armature comprises a metallic material and the sliding arm comprises a non-metallic material.

13. The solenoid assembly of claim 1, wherein:
the armature comprises a first portion and a second portion;
the armature comprises a first pin and a second pin spanning between the first portion and the second portion, and
the first portion is a mirror image of the second portion.

14. The solenoid assembly of claim 6, wherein:
the armature comprises a first portion and a second portion;
the armature comprises a first pin and a second pin spanning between the first portion and the second portion,
the first portion is a mirror image of the second portion,
the toothed gear is mounted to rotate on the first pin, and
a second toothed gear is mounted to rotate on the second pin.

15. The solenoid assembly of claim 14, wherein the first portion comprises a recess and a wall, wherein the toothed gear is a fan gear, and wherein the wall restricts the rotation of the first gear.

16. The solenoid assembly of claim 1, wherein the rotating member is coated with an anti-slip coating.

17. The solenoid assembly of claim 1, wherein the rotating member comprises a textured surface.

18. The solenoid assembly of claim 1, wherein the rotating member comprises a ball in a pocket.

19. The solenoid assembly of claim 2, wherein the rotating member comprises a plurality of balls in a respective plurality of pockets.

20. A valve assembly, comprising:
a flow path through a housing;
at least one valve configured to selectively open and close the flow path;
a solenoid assembly comprising:
a pole piece, comprising an inner chamber;
an electromagnetic signal source surrounding the pole piece;
an armature configured to move within the inner chamber when an electromagnetic signal is transmitted by the electromagnetic signal source; and
a rotating member installed within the armature and configured to rotate within the armature and against the inner chamber.

21. The valve assembly of claim 20, wherein the armature comprises a hollow portion, and wherein the solenoid assembly further comprises a sliding arm in the hollow portion, wherein the rotating member is further configured to rotate against the sliding arm, and wherein the sliding arm is configured to move in response to the armature movement when the electromagnetic signal is transmitted.

22. The valve assembly of claim 21, wherein the valve comprises a poppet valve linked to the sliding arm.

23. The valve assembly of claim 20, wherein the rotating member comprises one of a bearing ball, a cylinder, a spur gear, a fan gear, or a wheel.

24. A ferromagnetic armature for reciprocating in a solenoid assembly, comprising:
a first portion and a second portion, the first portion comprising a recess or a pocket, an inner side, an outer side and a thickness between the inner side and the outer side;
a first pin and a second pin spanning between the first portion and the second portion to couple the first portion to the second portion; and
a rotating member installed in the recess or in the pocket of the first portion,
wherein the rotating member is configured to rotate within the first portion;
wherein the rotating member comprises a diameter greater than the thickness of the first portion, such that the rotating member extends beyond the inner side and beyond the outer side.

25. The armature of claim 24, wherein the first portion is a mirror image of the second portion.

26. The armature of claim 24, wherein the rotating member is a fan gear, wherein the first portion comprises the recess, wherein the recess comprises a wall, wherein the fan gear is mounted to rotate on the first pin, and wherein the wall restricts the rotation of the fan gear.

27. The armature of claim 24, wherein the first portion comprises the pocket, and wherein the rotating member comprises a ball or a cylinder.

28. The armature of claim 28, wherein the first portion and the second portion comprise a plurality of pockets and a plurality of balls distributed in the pockets.
